(19) United States
(12) Patent Application Publication
(10) Pub. No.: US 2020/0102178 A1
(43) Pub. Date: Apr. 2, 2020

(54) Profile automatic alignment and stacking device

(71) Applicant: Xiaofeng Zhu, Xiamen City (CN)

(72) Inventor: Xiaofeng Zhu, Xiamen City (CN)

(21) Appl. No.: 16/702,542

(22) Filed: Dec. 4, 2019

(30) Foreign Application Priority Data
Sep. 18, 2019 (CN) 2019108819112

(51) Int. Cl. B65H 31/34; B65G 61/00; B65G 57/30

(52) U.S. Cl. CPC B65H 31/34; B65H 2301/422; B65G 57/305; B65G 61/00

(57) ABSTRACT

The invention discloses a profile automatic alignment and stacking device, which includes a casing. The casing is provided with a transmission mechanism, a screening mechanism and a pushing mechanism. The transmission mechanism transports the profile into the device. When the profile passes the screening mechanism, the screening mechanism A certain size of profile can be screened out, and a profile collection and collection cavity of a suitable size is screened out. A profile of inappropriate size is collected in another collection cavity. The pushing mechanism includes a driving motor and a rotating disc and a moving plate. The motor drives the rotating disc to rotate, which drives the horizontal movement of the moving plate to align and stack the appropriate size profiles. Through mechanical transmission, the work efficiency is improved.

### CROSS-REFERENCES TO RELATED APPLICATIONS

The present application claims priority from Chinese application No. 2019108819112 filed on Sep. 18, 2019 which is hereby incorporated by reference in its entirety.

### TECHNICAL FIELD

The invention relates to the field of industrial production, in particular to a device for automatically aligning and stacking profiles.

### BACKGROUND OF THE INVENTION

In industry, it is often necessary to perform alignment and stacking processing after the production of profiles and before processing the profiles. Automatic alignment and stacking of profiles is beneficial to the storage and processing of profiles in industry and to industrial assembly line operations;

At the current stage, in the process of automatic alignment and stacking of profiles, some manual alignment and stacking are used, which is time-consuming and labor-intensive, and can achieve mechanical alignment to complete the stacking of profiles, but cannot screen out the required size of profiles, resulting in different length The profiles have only one end aligned and stacked together.

### BRIEF SUMMARY OF THE INVENTION

The technical problem to be solved by the present invention is to provide an automatic alignment and stacking device for profiles, which overcomes the problems that the profile needs to be screened and needs to be aligned and stacked at the end face, and simplifies the automatic alignment and stacking of profiles.

The present invention is achieved by the following technical solutions.

The automatic profile stacking device of the present invention includes a casing, and the casing is provided with a working chamber for processing the profiles, a first collecting chamber for collecting the required profiles, and a second collection for collecting the remaining profiles. Cavity, a first storage cavity is provided in the lower end wall of the first collection cavity, a second storage cavity is provided in the lower end wall of the second collection cavity, and a first storage cavity is provided at the lower end of the first and second collection cavity A blocking block and a second blocking block. The upper end wall of the first collecting cavity is provided with a screening mechanism capable of screening the size of the profile. The working cavity is provided with a transmission mechanism that drives the movement of the profile. The right end wall of the working cavity is provided with A control mechanism for controlling the falling of the profile, a pushing mechanism for aligning and stacking profiles is provided in the left end wall of the first collecting cavity, and the screening mechanism includes an upward moving cavity provided in the upper end wall of the first collecting cavity, and the upper A resetting spring is fixedly connected to the lower end wall of the shifting cavity, a rotating plate is fixedly connected to the upper end of the resetting spring, and a fixing pin is rotatably connected to the rear end of the shifting cavity. and A first lower pressing block is provided in the working chamber. A vertical moving block in contact with the upper end of the rotating plate is provided at the right end of the rotating plate. A lifting cavity is provided in the upper end wall of the upward moving cavity. A lifting plate is provided, and a lifting spring connecting the lower end surface of the lifting plate and the lower end wall of the lifting cavity is provided in the lifting cavity, and the left end of the lifting plate is fixedly connected to penetrate the upper end wall of the lifting cavity and is located in the work. When the second lower pressure block in the cavity starts to work, the driving profile of the transmission mechanism moves to the right, and the screening material of the screening mechanism enters the first collection cavity through the channel opened by the control mechanism and Alignment and stacking are performed by the pushing mechanism, and unsuitable profiles enter the second collection cavity, thereby completing automatic alignment and stacking of the profiles.

Further, the transmission mechanism includes a transmission belt in the working chamber, a transmission block is fixedly connected to the lower end of the transmission belt, a rotation pin is fixedly connected to the front end of the transmission block, and a transmission plate is connected through the front end surface of the rotation pin. A stopper is fixedly connected to the lower end of the transmission block.

Further, the control mechanism includes a blocking plate provided in the working cavity, a first blocking plate cavity is provided at the right end of the blocking plate, and two vertical springs are fixedly connected to the lower end wall of the first blocking plate cavity, A triangular trapezoidal block is fixedly connected to the upper end of the vertical spring, a triangular plate is fixedly connected to the rear wall of the working cavity, and a second blocking plate cavity and a third blocking plate cavity are provided at the left end of the blocking plate, and the third blocking plate is There is a blocking triangle in the cavity that has a lower end penetrating the lower end wall of the third blocking plate cavity and fixedly connected to the upper end of the lifting plate located in the lifting cavity. A third blocking plate cavity lower end wall and a lifting block fixedly connected to the upper end of the vertical moving block located in the upward moving cavity; a right end wall of the working cavity is provided with a moving cavity, and the moving cavity is provided with the A moving block, a horizontal spring connecting the right end face of the moving block and the right end face of the moving cavity is fixedly connected in the moving cavity, and the left end of the left end of the moving block is fixedly connected through the left end face of the moving cavity and is located in the work Intracavity Block, a connection plate is fixedly connected to the left end surface of the middle block, a baffle plate located in the working cavity is fixedly connected to the lower end of the connection plate, and horizontal movement in the working cavity is fixedly connected to the lower end of the connection plate. A connecting spring is provided in the working cavity to connect the right end surface of the blocking plate and the left end surface of the horizontal moving plate.

Further, the pushing mechanism includes a pushing cavity, a driving motor is fixedly connected to a rear wall of the pushing cavity, the driving motor is dynamically connected with a power shaft, and a rotating disk is fixedly connected at the front end of the driving shaft. A translation plate is provided at the rear end of the rotating disk, and a translation plate cavity is provided in the translation plate, and a rotation pin fixedly connected to the rear end surface of the rotation disk is provided in the translation plate cavity. The right end surface is fixedly connected with a fixed block having a right end penetrating the right end wall of the pushing cavity and located in the first collection cavity, and a right end of the fixed block is fixedly connected with a moving plate located in the first collection cavity.

Further, the return spring is initially in a relaxed state, and the lifting block is initially not located in the cavity of the third blocking plate. When the right end of the rotating plate is lifted, the upper end of the lifting block just rises to enter the third Blocking plate cavity.

Further, the lifting spring is initially in a compressed state, and the blocking triangle block is initially located in the cavity of the second blocking plate. When the second lower pressing block drives the lifting plate and the blocking triangle block to a minimum, Point, the blocking triangle just leaves the second blocking plate cavity.

Further, the vertical spring is initially in a compressed state, at this time, the upper end of the triangular trapezoidal block is located in the working cavity, the lower end of the triangular trapezoidal block is located in the first blocking plate cavity, and the height of the triangular trapezoidal block is Less than the depth of the first blocking plate cavity.

Further, the connecting spring is initially in a relaxed state, and the pulling force of the connecting spring is greater than the frictional force received by the blocking plate.

Further, the horizontal spring is initially in a compressed state, and the sum of the elastic force of the horizontal spring and the friction force received by the horizontal moving plate and the elastic force of the connection spring is less than the thrust force of the baffle when the profile is pressed.

The device has the advantages of simple structure and convenient operation. The device can automatically align and stack the profiles, and can screen out the profiles of the required size, and can align and store the profiles of the required size with high degree of automation.

### BRIEF DESCRIPTION OF THE DRAWINGS

In order to more clearly illustrate the embodiments of the invention or the technical solutions in the prior art, the drawings used in the description of the embodiments or the prior art will be briefly introduced below. Obviously, the drawings in the following description are merely For some embodiments of the invention, for those skilled in the art, other drawings can be obtained based on these drawings without paying creative labor.

FIG. 1 is a schematic structural diagram of an embodiment of the present invention;

FIG. 2 is an enlarged schematic view of the structure at A in FIG. 1 according to an embodiment of the present invention; FIG.

FIG. 3 is an enlarged schematic view of the structure at B in FIG. 1 according to the embodiment of the present invention; FIG.

FIG. 4 is an enlarged schematic view of C-C in FIG. 1 according to an embodiment of the present invention; FIG.

FIG. 5 is a schematic diagram of an enlarged structure of D-D in FIG. 1 according to an embodiment of the present invention.

### DETAILED DESCRIPTION OF THE INVENTION

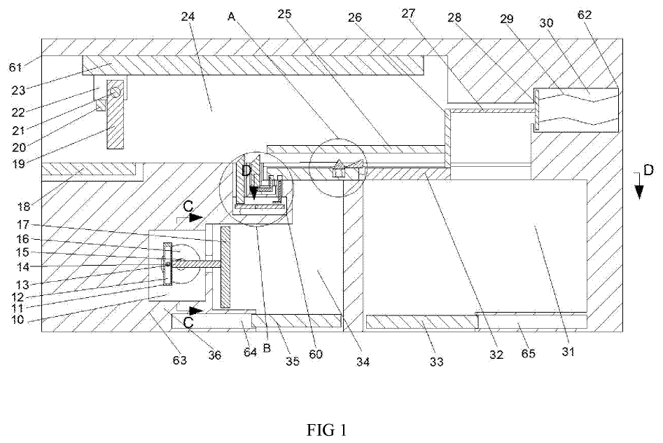

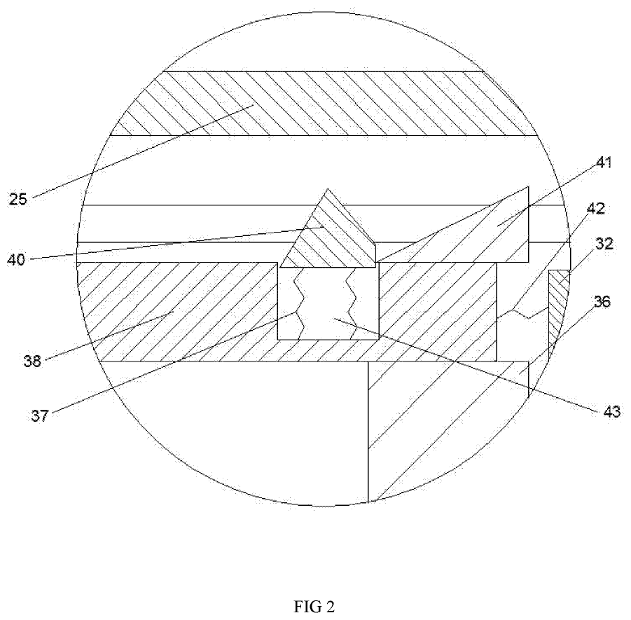

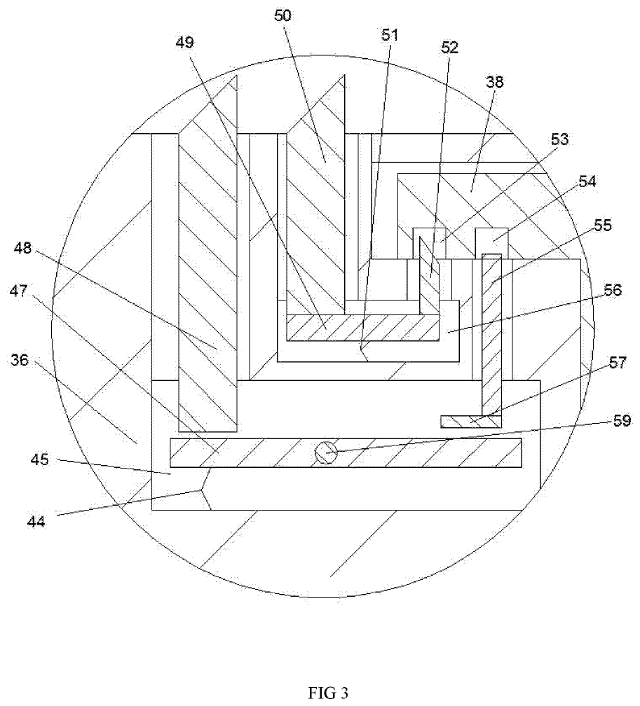

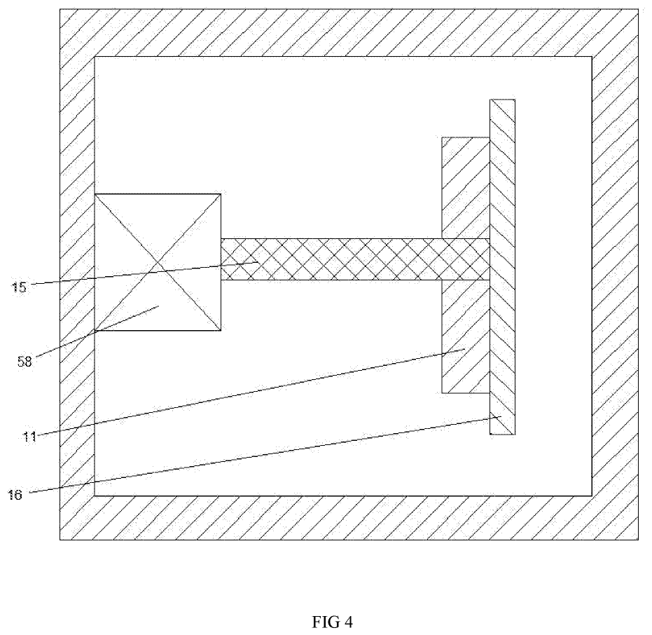

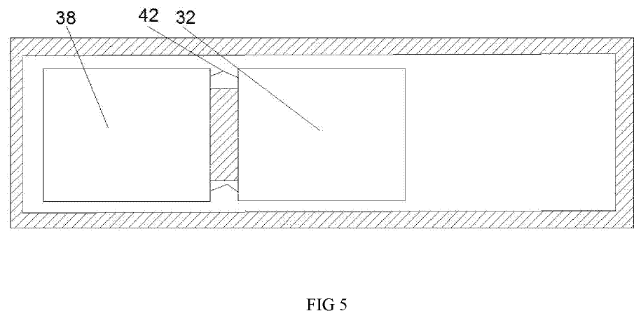

The present invention will be described in detail below with reference to FIGS. 1-5. Among them, for convenience of description, the orientation described below is defined as follows: the up-down, left-right, front-back direction described below is consistent with the up-down, left-right, front-back direction of the projection relationship of FIG. 1 itself.

A profile automatic alignment and stacking device described in conjunction with FIGS. 1-5 includes a casing 36, and the casing 36 is provided with a working chamber 24 for processing the profiles and a first collecting chamber 34 for collecting the required profiles. And a second collection cavity 31 for collecting the remaining profiles, a first storage cavity 64 is provided in the lower end wall of the first collection cavity 34, and a second storage cavity 65 is provided in the lower end wall of the second collection cavity 31. The lower ends of the first collecting cavity 34 and the second collecting cavity 31 are respectively provided with a first blocking block 35 and a second blocking block 33, and an upper end wall of the first collecting cavity 34 is provided with a screening mechanism 60 capable of screening the size of the profile. A transmission mechanism 61 is provided in the working cavity 24 to drive the profile. A control mechanism 62 for controlling the falling of the profile is provided in the right end wall of the working cavity 24. A pusher for aligning the stacked profiles is provided in the left end wall of the first collecting cavity 34. Mechanism 63, the screening mechanism 60 includes an upward movement cavity 45 provided in the upper end wall of the first collection cavity 34, a lower end wall of the upward movement cavity 45 is fixedly connected with a return spring 44, and an upper end of the return spring 44 is fixedly connected There is a rotating plate 47, and the rear end of the upward moving cavity 45 is rotationally connected and fixed A pin 59 is provided in the upper moving cavity 45 with an upper end penetrating the upper end wall of the upper moving cavity 45 and located in the working cavity 24 as a first lower pressure block 48. The right end of the rotating plate 47 is provided with the rotating plate. 47 A vertical moving block 57 in contact with the upper end of the upper moving cavity 45 is provided with a lifting cavity 56 in an upper end wall thereof, a lifting plate 49 is provided in the lifting cavity 56 and a connecting plate is provided in the lifting cavity 56 A lifting spring 51 at the lower end surface of 49 and the lower end wall of the lifting cavity 56 is fixedly connected to the left end of the lifting plate 49 with a second lower pressure block 50 penetrating the upper end wall of the lifting cavity 56 and located in the working cavity 24, starting During operation, the profile driven by the transmission mechanism 61 moves to the right, and the profile of the suitable size selected by the screening mechanism 60 enters the first collection cavity 34 through the channel opened by the control mechanism 62 and is pushed by the pushing mechanism. 63 performs alignment and stacking, and unsuitable profiles enter the second collection cavity 31, thereby completing automatic alignment and stacking of the profiles.

Advantageously, the transmission mechanism 61 includes a transmission belt 23 in the working cavity 24, a transmission block 22 is fixedly connected to the lower end of the transmission belt 23, and a rotation pin 21 is fixedly connected to the front end of the transmission block 22, and the rotation pin A front end surface of 21 is connected with a transmission plate 19, and a stopper 20 is fixedly connected to a lower end of the transmission block 22.

Advantageously, the control mechanism 62 includes a blocking plate 38 provided in the working cavity 24, a first blocking plate cavity 43 is provided at the right end of the blocking plate 38, and a lower end wall of the first blocking plate cavity 43 is fixedly connected with Two vertical springs 37 are fixedly connected to the triangular trapezoidal block 40 at the upper end, a triangular plate 41 is fixedly connected to the rear wall of the working cavity 24, and a second blocking plate cavity 53 is provided at the left end of the blocking plate 38 And a third blocking plate cavity 54, the third blocking plate cavity 53 is provided with a lower end penetrating the lower end wall of the third blocking plate cavity 53 and fixedly connected to the upper end of the lifting plate 49 located in the lifting cavity 56. In the blocking triangle block 52, a lower end of the third blocking plate cavity 54 penetrates the lower end wall of the third blocking plate cavity 54 and is fixedly connected to the upper end of the vertical moving block 57 located in the upward moving cavity 45. Lifting block 55, a moving cavity 30 is provided at the right end wall of the working cavity 24, and the moving cavity 28 is provided in the moving cavity 30. The moving cavity 30 is fixedly connected to the right end surface of the moving block 28 and the moving cavity 30. The horizontal spring 29 on the right end face of the moving cavity 30, and the left end face of the moving block 28 is fixedly connected to the left end An intermediate block 27 passing through the left end surface of the moving cavity 30 and located in the working cavity 24 is fixedly connected to the left end surface of the intermediate block 27 with a connection plate 26, and the lower end of the connection plate 26 is fixedly connected to the working cavity 24. An inner baffle 25, the lower end surface of the connection plate 26 is fixedly connected with a horizontal moving plate 32 located in the working cavity 24, and the working cavity 24 is provided with a right end surface connecting the blocking plate 38 and the horizontal movement. The connection spring 42 on the left end surface of the plate 32.

Beneficially, the pushing mechanism 63 includes a pushing cavity 10, a driving motor 58 is fixedly connected to the rear wall of the pushing cavity 10, and the driving motor 58 is power-connected with a power shaft 15 fixed at the front end. A rotating disk 16 is connected, and a translation plate 11 is provided at the rear end of the rotation disk 16. A translation plate cavity 12 is provided in the translation plate 11, and a front end surface is fixedly connected to the translation plate cavity 12. The rotating pin 14 at the rear end of the disc 16 is rotated, and the right end of the translation plate 11 is fixedly connected with a fixing block 13 having a right end penetrating the right end wall of the pushing cavity 10 and located in the first collecting cavity 34. The right end surface is fixedly connected with a moving plate 17 located in the first collecting cavity 34.

Beneficially, the return spring 44 is initially in a relaxed state, and the lifting block 55 is not initially located in the third blocking plate cavity 54. When the right end of the rotating plate 47 is lifted, the upper end of the lifting block 55 is just raised to Into the third blocking plate cavity 54.

Advantageously, the lifting spring 51 is initially in a compressed state, and the blocking triangle block 52 is initially located in the second blocking plate cavity 53. When the second lower pressing block 50 drives the lifting plate 49 and the blocking The triangular block 52 descends to the lowest point, and the blocking triangular block 52 just leaves the second blocking plate cavity 53.

Beneficially, the vertical spring 37 is initially in a compressed state. At this time, the upper end of the triangular trapezoidal block 40 is located in the working cavity 24, and the lower end of the triangular trapezoidal block 40 is located in the first blocking plate cavity 43. The height of the triangular trapezoidal block 40 is smaller than the depth of the first blocking plate cavity 43.

Beneficially, the connecting spring 42 is initially in a relaxed state, and the pulling force of the connecting spring 42 is greater than the frictional force received by the blocking plate 38.

Beneficially, the horizontal spring 29 is initially in a compressed state, and the sum of the elastic force of the horizontal spring 29 and the friction force received by the horizontal moving plate 32 and the elastic force of the connection spring 42 is less than that of the baffle 25 received by the profile Thrust.

The sequence of mechanical actions of the entire device:

1: Start the device, the conveyor belt 18 transports the profile into the working chamber 24, the conveyor belt 23 drives the conveyor block 22 to the right, so that the conveyor plate 19 and the stopper 20 are moved to the right. When the conveyor plate 19 contacts the right end face of the profile The profile pushes down the first lower pressing block 48, and the first lower pressing block 48 will press against the rotating plate 47. Under the action of the fixing pin 59, the left end of the rotating plate 47 descends and the right end rises and the return spring 44 is compressed, and the rotating plate 47 The right end rises against the vertical moving block 57 and the lifting block 55. The lifting block 55 enters the third blocking plate cavity 54. The lifting block 55 moves the blocking block 38 to the right, and the profile pushes down the second lower block 50. Therefore, the lifting plate 49 and the blocking triangle 52 are moved downward, the blocking triangle 52 leaves the second blocking plate cavity 53, the blocking triangle 52 no longer blocks the blocking plate 38 from moving to the right, and due to the blocking of the blocking block 20, the transfer plate 19 will drive the profile to the right along with the conveying plate 19, the profile will move to the right to contact the baffle 25, and the baffle 25 will move to the right together, so that the connection plate 26 and the horizontal moving plate 32 will move to the right together, the connection plate 26 drives the middle block 27 and moves the block 28 to the right The horizontal spring 29 is moved and compressed, and the horizontal moving plate 32 is moved to the right to stretch the connecting spring 42. At this time, the profile has not touched the triangular trapezoidal block 40. Therefore, under the action of the vertical spring 37, the triangular trapezoidal block 40 rises and the triangle The right end of the trapezoidal block 40 abuts on the left end of the triangular plate 41. The blocking plate 38 is blocked by the triangular plate 41 and the lifting block 55 and cannot move to the right. The channel does not open. The transfer plate 19 drives the profile to continue to the right to contact the triangular trapezoidal block 40. The trapezoidal block 40 presses down and compresses the vertical spring 37, and at this time, the triangular plate 41 no longer blocks the blocking plate 38 from moving to the right;

2: If the length of the profile is moderate, the left end of the profile no longer contacts the first lower pressing block 48. Under the action of the spring 44 and the fixing pin 59, the left end of the rotating plate 47 is lifted up and the right end is lowered. At this time, the block 57 is vertically moved and lifted. The block 55 receives the downward movement of its own gravity, the lifting block 55 leaves the third blocking plate cavity 54, the lifting block 55 no longer blocks the blocking plate 38 from moving to the right, and the left end of the profile is still pressed on the second lower pressing block 50, blocking The triangle block 52 does not prevent the blocking plate 38 from moving to the right. Under the action of the connecting spring 42, the blocking plate 38 moves to the right. The first collecting cavity 34 is connected to the connecting spring 42 and the profile falls into the first collecting cavity 34. At this time, the driving motor 58 drives the power shaft 15 to rotate, thereby driving the rotating disk 16 to rotate, thereby driving the translation plate 11 to reciprocate left and right, and the translation plate 11 drives the movement plate 17 to reciprocate left and right, and then falls into the first collection chamber 34 The profiles are pushed to the right end face of the first collection cavity 34 to complete the alignment and stacking, and the first blocking block 35 can be manually pushed into the first storage cavity 64 to remove the stacked profiles;

3: If the profile is shorter than the required length, the left end of the profile no longer touches the first lower pressing block 48. Under the action of the elasticity of the return spring 44 and the fixing pin 59, the left end of the rotating plate 47 is lifted up and the right end is lowered. At this time, the block is moved vertically. 57 and the lifting block 55 receive their own gravity downward movement, the lifting block 55 leaves the third blocking plate cavity 54, the lifting block 55 no longer blocks the blocking plate 38 from moving to the right, and the left end of the profile no longer contacts the second lower pressing block 50, Under the action of the elastic force of the lifting spring 51, the upward movement of the lifting plate 49 drives the second lower pressing block 50 and the blocking triangle 52 to move upward, the blocking triangle 52 enters the second blocking plate cavity 53, and the blocking plate 38 moves to the right. The first collecting cavity 34 is not connected with the connecting spring 42. The conveying plate 19 drives the profile to continue through the triangular plate 41. Since the horizontal moving plate 32 has moved to the right, the second collecting cavity 31 is connected to the connecting spring 42 and the profile falls to In the connection spring 42, if the profile is longer than the required length, the left end of the profile continues to press the first lower pressing block 48, and the first lower pressing block 48 will press the rotating plate 47, and the plate will be rotated by the fixing pin 59 47 Left end fall Right end rise and return spring 44 Compression, the right end of the rotating plate 47 rises to oppose the vertical moving block 57 and the lifting block 55. The lifting block 55 enters the third blocking plate cavity 54 and blocks the blocking plate 38 from moving to the right. The first collecting cavity 34 is not connected to the spring 42 When connected, the conveying plate 19 drives the profile to continue to the left end of the profile and no longer touch the first lower pressure block 48. Under the action of the elasticity of the return spring 44 and the fixing pin 59, the left end of the rotating plate 47 is lifted up and the right end is lowered. The block 57 and the lifting block 55 receive their own gravity downward movement, the lifting block 55 leaves the third blocking plate cavity 54, the lifting block 55 no longer blocks the blocking plate 38 from moving to the right, the blocking plate 38 moves to the right, and the first collecting chamber 34 It is connected to the connection spring 42, but at this time, the right end of the profile is already on the upper surface of the triangular plate 41, so it will not fall into the connection spring 42, because the blocking plate 38 and the horizontal moving plate 32 move to the right, the second collection chamber 31 is connected to The spring 42 is turned on, and the profile is dropped into the connecting spring 42 to complete the profile that does not meet the length. The second blocking block 33 can be manually pushed into the second storage cavity 65 to take out the profile that does not meet the requirements;

4: After the profile is dropped, the baffle 25 is no longer pressed. Under the elastic force of the horizontal spring 29, the moving block 28, the middle block 27 and the connecting plate 26 move to the left, and the connecting plate 26 drives the baffle 25 and the horizontal moving plate. 32 moves to the left, the horizontal moving plate 32 pushes the blocking plate 38 to the left through the connection spring 42, and the device completes resetting.

The above embodiments are only for explaining the technical concept and characteristics of the present invention, and the purpose thereof is to enable those skilled in the art to understand and implement the content of the present invention, but not to limit the protection scope of the present invention. Any equivalent change or modification made according to the spirit and essence of the present invention should be covered by the protection scope of the present invention.

1. An automatic alignment and stacking device for profiles includes a casing, which is characterized in that: An automatic alignment and stacking device for profiles in the present invention includes a casing, and the casing has a working chamber for processing the profiles and a required profile. A first collection chamber for collecting and a second collection chamber for collecting the remaining profiles, a first storage chamber is provided in a lower end wall of the first collection chamber, and a second storage chamber is provided in a lower end wall of the second collection chamber, A first blocking block and a second blocking block are respectively provided at the lower ends of the first and second collection chambers, and a screening mechanism capable of screening the size of the profile is provided at the upper end wall of the first collection chamber, and the working chamber is provided with A transmission mechanism that drives the movement of the profile, a control mechanism for controlling the falling of the profile is provided in the right end wall of the working cavity, and a pushing mechanism for aligning and stacking the profile is provided in the left end wall of the first collecting cavity, and the screening mechanism includes the first An upward moving cavity is arranged in the upper end wall of the collecting cavity. A return spring is fixedly connected to the lower end wall of the upward moving cavity. A rotating plate is fixedly connected to the upper end of the return spring. A pin, the upper end of which is provided with an upper end penetrating the upper end wall of the upward movement chamber and located in the first lower pressure block in the working chamber, and the right end of the rotating plate is provided with a vertical movement contacting the upper end of the rotating plate Block, a lifting cavity is provided in the upper end wall of the upward moving cavity, a lifting plate is provided in the lifting cavity, and a lifting spring connecting the lower end surface of the lifting plate and the lower end wall of the lifting cavity is provided in the lifting cavity, The left end of the lifting plate is fixedly connected with a second lower pressure block that penetrates the upper end wall of the lifting cavity and is located in the working cavity. When the work starts, the driving profile of the transmission mechanism moves to the right and the screening of the screening mechanism Appropriately-sized profiles enter the first collection cavity through the channel opened by the control mechanism and are aligned and stacked by the pushing mechanism, and unsuitable profiles enter the second collection cavity, thereby completing automatic alignment and stacking of the profiles.

2. The device for automatically aligning and stacking profiles according to claim 1, wherein the transmission mechanism includes a transmission belt in the working chamber, a transmission block is fixedly connected to the lower end of the transmission belt, and the front end of the transmission block is fixed A rotation pin is connected, a front end surface of the rotation pin is connected to a transmission plate, and a stopper is fixedly connected to the lower end of the transmission block.

3. The device for automatically aligning and stacking profiles according to claim 1, wherein the control mechanism includes a blocking plate provided in the working cavity, and a first blocking plate cavity is provided at the right end of the blocking plate, and The lower end wall of the first blocking plate cavity is fixedly connected with two vertical springs. The upper end of the vertical spring is fixedly connected with a triangular trapezoid block. The rear end wall of the working cavity is fixedly connected with a triangular plate. A second end of the blocking plate is provided with a second A blocking plate cavity and a third blocking plate cavity, the third blocking plate cavity is provided with a blocking triangle whose lower end penetrates the lower end wall of the third blocking plate cavity and is fixedly connected to the upper end of the lifting plate located in the lifting cavity. A lifting block having a lower end penetrating the lower end wall of the third blocking plate cavity and fixedly connected to the upper end of the vertical moving block located in the upward moving cavity in the third blocking plate cavity, the working cavity The right end wall is provided with a moving cavity. The moving cavity is provided with the moving block. The moving cavity is fixedly connected with a horizontal spring connecting the right end surface of the moving block and the right end surface of the moving cavity. The left end of the moving block Face connection The left end passes through the left end of the moving cavity and is located in the middle block of the working cavity. The left end of the middle block is fixedly connected with a connection plate, and the lower end of the connection plate is fixedly connected with a baffle plate located in the working cavity. A horizontal moving plate located in the working cavity is fixedly connected to the lower end surface of the connecting plate, and a connecting spring connecting the right end surface of the blocking plate and the left end surface of the horizontal moving plate is provided in the working cavity.

4. The device for automatically aligning and stacking profiles according to claim 1, wherein the pushing mechanism comprises a pushing cavity, a rear end wall of the pushing cavity is fixedly connected with a driving motor, and the driving motor is dynamically connected with A power shaft, a rotating disk is fixedly connected to the front end of the power shaft, a translation plate is provided at the rear end of the rotating disk, a translation plate cavity is provided in the translation plate, and a front end surface is fixedly connected in the translation plate cavity. A rotating pin at the rear end surface of the rotating disc, a right end of the translation plate is fixedly connected with a fixing block having a right end penetrating the right end wall of the pushing cavity and located in the first collecting cavity, and the right end face of the fixing block is fixed A moving plate located in the first collection cavity is connected.

5. The automatic profile stacking device according to claim 3, characterized in that: the return spring is initially in a relaxed state, the lifting block is not initially located in the cavity of the third blocking plate, and when the right end of the rotating plate is Lifting, the upper end of the lifting block just rises into the third blocking plate cavity.

6. The automatic profile stacking device according to claim 3, wherein the lifting spring is initially in a compressed state, and the blocking triangle is initially in the cavity of the second blocking plate. The pressing block drives the lifting plate and the blocking triangle block to descend to the lowest point, and the blocking triangle block just leaves the cavity of the second blocking plate.

7. The automatic profile stacking device according to claim 3, characterized in that: the vertical spring is initially in a compressed state, at this time, the upper end of the triangular trapezoidal block is located in the working cavity, and the lower end of the triangular trapezoidal block The triangular trapezoidal block is located in the first blocking plate cavity, and the height of the triangular trapezoidal block is smaller than the depth of the first blocking plate cavity.

8. The automatic profile stacking device according to claim 3, wherein the connecting spring is initially in a relaxed state, and the pulling force of the connecting spring is greater than the frictional force received by the blocking plate.

9. The automatic profile stacking device according to claim 3, wherein the horizontal spring is initially in a compressed state, the elastic force of the horizontal spring and the frictional force received by the horizontal moving plate, and the sum of the spring forces is less than the thrust force of the baffle when the profile is pressed.
